(19) United States
(12) Patent Application Publication
(10) Pub. No.: US 2024/0282978 A1
(43) Pub. Date: Aug. 22, 2024

(54) CELL ASSEMBLY FOR CONTROLLED GUIDING OF REACTIVE FLUIDS

(71) Applicant: Robert Bosch GmbH, Stuttgart (DE)

(72) Inventors: Erhard Hirth, Ellhofen (DE); Harald Bauer, Ehningen (DE)

(21) Appl. No.: 18/570,246

(22) PCT Filed: Jun. 14, 2022
(86) PCT No.: PCT/EP2022/066079

§ 371 Date: Dec. 14, 2023

(30) Foreign Application Priority Data
Jun. 17, 2021 (DE) 10 2021 206 220.2

(51) Int. Cl. H01M 4/86; C25B 9/75; C25B 9/77; C25B 11/032; H01M 4/90; H01M 8/1004

(52) U.S. Cl. CPC H01M 4/8657; C25B 9/75; C25B 9/77; C25B 11/032; H01M 4/8605; H01M 4/9083; H01M 8/1004

(57) ABSTRACT

The presented invention relates to a cell assembly (100) for the controlled guiding of reactive fluids, wherein: the cell assembly (100) comprises a membrane (101), which has a first side and a second side opposite from the first side; on each of the first side and the second side, a catalyst layer (103) and a microporous layer (105) are disposed; the microporous layer (105) and/or the catalyst layer (103) of at least one side is profiled in such a way that the surface roughness of the catalyst layer (103) differs from the surface roughness of the microporous layer (105), so that the catalyst layer (103) and the microporous layer (105) fit together in parts.

### BACKGROUND

The invention presented relates to a cell assembly for the controlled guiding of reactive fluids, a manufacturing method for producing the cell assembly, a fuel cell system and an electrolyzer with the cell assembly presented.

Fuel cell systems and electrolyzers generally comprise cell stacks of cell assemblies of different individual cells in which reactive fluids are guided in order to react together in the case of a fuel cell system or to be discharged separately in the case of an electrolyzer.

Each individual cell assembly of a cell stack consists of a large number of different layers. A semi-permeable separating layer, e.g., a membrane, is always arranged in the center of a cell assembly, which is surrounded on two opposite sides by a catalyst layer. This separating layer can be an ion-conducting polymer layer that is electronically separating and permeable to water.

Since the respective cell assemblies are supplied via macroscopic gas channels in bipolar plates, a gas diffusion electrode consisting of a fiber fleece and a microporous layer in the direction of the catalyst layer is used as a mediator between the macroscopic gas channels and the microscopic flow areas of a cell assembly.

A bipolar plate comprises a flow field which, with a sheet thickness of e.g., 0.1 mm and curved channels, has web widths of approx. 0.1 to 0.2 mm, which are approximately 0.5 mm apart.

Fiber nonwovens have mesh sizes in the range of 0.05 to 0.4 mm.

Catalyst particles of a catalyst layer have a size in the range of less than 0.001 mm.

For manufacturing reasons, a first sub-assembly of membrane and catalyst layers (carbon coated membrane CCM) is usually produced and combined with a second sub-assembly, the gas diffusion layer (GDL), consisting of carbon backbone (GDB) and microporous layer (MPL).

For the functions of mass transport, electrical conductivity and avoidance of cavities in which water can accumulate, an intimate assembly must be created, i.e., the first partial assembly must be intimately connected to the second partial assembly. This can be done before insertion between two bipolar plates during stacking by laminating or also during a stacking process by pressing.

The catalyst layer is usually relatively smooth and flat, especially if the catalyst layer was produced on a transfer foil and then transferred to the membrane, as the smooth side of the catalyst layer that was previously on the transfer foil then faces outwards, which is known as the “decal process”.

An MPL overlay on a GDL is usually “wavy”, as the unevenness of a fiber fleece is reproduced with its large tolerances, so that a flat assembly cannot be achieved when placed on a membrane. The carbon black used in the MPL and catalyst layer is usually largely identical, so that the MPL surface is wavy but also smooth. It is hardly possible to press it against the membrane before a stacking process, as the GDL fleece yields irregularly. When stacking, pressure can only be applied in the area of the respective webs; the assembly lies loosely in the area of the respective gas channels.

### SUMMARY

In the context of the invention presented, a cell assembly, a manufacturing method, a fuel cell system and an electrolyzer are presented. Further features and details of the invention will emerge from the respective dependent claims, the description, and the drawings. Features and details that are described in connection with the cell assembly according to the invention naturally also apply in connection with the fuel cell system according to the invention, the electric motor according to the invention and the manufacturing method according to the invention and vice versa, so that the disclosure always refers or can refer to the individual aspects of the invention in a reciprocal manner.

The invention presented serves in particular to provide a robust cell assembly for use in a fuel cell system or an electrolyzer.

Thus, according to a first aspect of the invention presented, a cell assembly for the controlled guiding of reactive fluids is presented. The cell assembly comprises a membrane with a first side and a second side opposite the first side. A catalyst layer and a microporous layer are each arranged on the first side and the second side, wherein the microporous layer and/or the catalyst layer of at least one side is or are profiled in such a way that a surface roughness of the catalyst layer differs from a surface roughness of the microporous layer, so that the catalyst layer and the microporous layer fit together in parts.

In the context of the presented invention, a catalyst layer is to be understood as a layer of a cell assembly comprising a material that minimizes a reaction enthalpy of a reaction of fluids flowing through the cell assembly.

In the context of the invention presented, a microporous layer is to be understood as a layer of a cell assembly which has pores through which fluids guided from a bipolar plate into the cell assembly are directed or guided towards or away from a respective catalyst layer in a controlled mass flow.

In the context of the invention presented, a profiling or a profiled layer is to be understood as a surface of a layer which has a structure which varies in height in parts, as is known, for example, from tire treads. In particular, a profiled layer can have a pattern that comprises raised and flat areas so that the raised areas can penetrate into flat areas of another layer and vice versa.

The cell assembly presented is based on the principle that at least one of the catalyst layers and the microporous layers of a cell assembly is profiled, so that a surface roughness of the microporous layers and a surface roughness of the catalyst layers of the cell assembly differ. The different surface roughnesses cause the different layers, i.e., the microporous layers and the catalyst layers, to form a bond in which the contacting layers fit together in parts. This means, for example, that raised areas of a profile of a catalyst layer penetrate into flat areas of a microporous layer and vice versa.

Fitting together in parts of the catalyst layer and the microporous layer according to the invention achieves a uniform bonding of the catalyst layer and the microporous layer, so that a continuous and robust contact area is created, which reliably prevents delamination. In particular, the different surface roughnesses of the various layers of the cell assembly according to the invention achieve a maximized contact surface between the various layers, which interlock with one another, for example.

Due to the prevention of delamination processes by the profiling provided according to the invention, ageing phenomena of a cell stack, such as overloading of individual zones, are prevented and improvements in electrical contacting and heat dissipation are achieved. Furthermore, water accumulation in poorly connected zones of a cell assembly is avoided. Accordingly, the cell assembly according to the invention leads to maximized current densities and correspondingly maximized power densities, especially in fuel cell systems.

Furthermore, the cell assembly according to the invention enables a minimization of a contact pressure applied in a cell stack and a simplified design as a result, as well as a minimized installation space requirement and a minimized weight using a compact or reduced tensioning system compared to the state of the art.

It may be provided that the microporous layer is hardened by means of a binder so that mechanical forces acting on the microporous layer are evenly distributed in the microporous layer.

By means of a binder used in the production of the microporous layer according to the invention, such as polyvinylidene fluoride (PVDF), which causes the microporous layer not to remain flexible, as is usual in the prior art when using ductile PTFE, but to harden or become rigid, it can be achieved that mechanical forces acting on the microporous layer are evenly distributed in the microporous layer. Accordingly, a rigid microporous layer can be used to provide a profiling that remains intact even during a pressing or lamination process and fits together with a contacted layer particularly efficiently. In other words, a rigid microporous layer prevents deformation of the profiling and a mechanical force that is provided during compression is not damped locally, but is guided evenly through a corresponding layer, so that the corresponding layer is particularly easy to profile, for example by means of a profile roller.

It is also possible that the microporous layer is applied to a carrier layer or, in particular, is only hardened by the binder.

By using a carrier layer, such as a carbon fleece, a particularly thin microporous layer of e.g., 50 μm thickness can be provided.

By using a microporous layer that is hardened by a binder, i.e., produced without a carrier layer, a so-called “free-standing microporous layer” can be provided, which is particularly easy to profile, for example by using a profiled decal film or by using a profiling tool such as a profiling roller.

It may also be provided that the binder comprises electrically conductive components and/or mechanically stiffening components and/or hydrophobizing agents.

A particularly efficient electrical contact between the microporous layer and a catalyst layer can be achieved by means of a binder comprising electrically conductive components such as graphite or carbon black.

By means of mechanically stiffening components, such as carbon short fibers or glass carbon particles, a particularly rigid microporous layer can be provided, which distributes the mechanical force provided during a compression process particularly evenly within a corresponding cell assembly. In particular, mechanically stiffening components in a microporous layer, which is or was dry pressed or extruded, e.g., by a casting process or low-solvent, enable a particularly uniform layer thickness, which is particularly easy to profile, e.g., using a profiling roller.

A hydrophobizing agent, such as particles or threads made of polytetrafluoroethylene (PTFE) or silanes, can be used to minimize the accumulation of water in a cell assembly and the resulting delamination, in particular through the formation of water ice.

It may also be provided that components of a material forming the microporous layer are larger or smaller than components of a material forming the catalyst layer.

Different components in the microporous layer and the catalyst layer, which have a different size, can achieve a different profiling, i.e., a different surface roughness of the microporous layer and the catalyst layer, so that the microporous layer and the catalyst layer fit together particularly strongly or widely and an intimate connection of the microporous layer and the catalyst layer is achieved. For example, the microporous layer can be enriched with graphite components and the catalyst layer can be enriched with carbon black components.

It may further be provided that at least some of the components of the material forming the microporous layer are larger than the components of the material forming the catalyst layer by at least a factor of 2, preferably at least a factor of 5, particularly preferably at least a factor of 10.

For example, it may be provided that the microporous layer is enriched with graphite components greater than a threshold value and the catalyst layer is enriched with soot components less than a threshold value. In particular, the threshold value can be 1 μm.

In order to enable the introduction of particularly large components, such as 5 μm, preferably 30 μm graphite particles or graphite fibers with diameters between 5 μm and 10 um into the microporous layer, it can be provided that the microporous layer is particularly thick, e.g., with a thickness between 50 μm and 250 μm, preferably between 100 μm and 200 μm, particularly preferably 150 μm.

In a second aspect, the presented invention relates to a manufacturing method for manufacturing a cell assembly. The manufacturing method comprises an arranging step for arranging a microporous layer on a catalyst layer of a membrane, wherein the microporous layer and/or the catalyst layer of at least one side is profiled such that a surface roughness of the catalyst layer differs from a surface roughness of the microporous layer so that the catalyst layer and the microporous layer fit together in parts.

The manufacturing method according to the invention is used in particular for manufacturing the cell assembly according to the invention.

In the manufacturing method according to the invention, a microporous layer and a catalyst layer are brought into contact with each other or arranged next to each other. At least one of the microporous layer and the catalyst layer has a profiling, so that an intimate connection between the catalyst layer and the microporous layer is created, in which the microporous layer and the catalyst layer fit together in parts or interlock with each other.

It may be provided that the manufacturing method comprises a providing step for providing a material forming the catalyst layer on a film having a profiled structure and/or a providing step for providing a material forming the microporous layer on a film having a profiled structure.

To produce a profiled layer, such as a microporous layer or a catalyst layer, the layer can be applied to a profiled film, which has, for example, a negative of a profile of the layer. For this purpose, a material forming the layer can be pressed onto the film or poured onto the film. After removing the layer from the film, a profiled layer remains which can be further processed in the method according to the invention.

It may further be provided that the manufacturing method comprises a profiling step for profiling the catalyst layer and/or the microporous layer by means of a profiling tool, and/or a profiling step for profiling the microporous layer by mixing a material forming the microporous layer using a component whose grain size is larger or smaller than the grain size of a component of the catalyst layer.

By using a profiling tool, such as a profiling roller with a pattern, such as a diamond pattern, or any other profiling tool technically suitable for creating a profile, in particular a laser or a punch, a macroscopic profile can be achieved, resulting in particularly rough surfaces that can fit together and, as a result, be strongly interlocked. For example, a microporous layer with a uniform layer thickness of 100 μm in particular can be provided with profiling patterns at intervals of 50 μm in particular, so that the profiling patterns regularly provide particularly rough or deep contact points in addition to a basic roughness, which enable particularly good interlocking or fitting together.

By using materials with different grain sizes, microscopic profiling can be achieved, resulting in a particularly widely distributed roughness of a corresponding surface, so that a particularly large contact area is created in which the respective layers fit together. The respective components can, for example, have particularly large particles and/or fibers, which can, for example, be 5 μm, preferably 30 μm in size and have diameters between 5 μm and 10 um. Accordingly, the respective components can at least partially protrude from a surface and “roughen” or structure it accordingly. The number and size distribution of the respective components can be selected in such a way that a predetermined proportion of the surface area of e.g., 25% is formed by respective components that protrude over a base area of the surface.

In a third aspect, the invention presented relates to a fuel cell system with a possible embodiment of the cell assembly presented.

In a fourth aspect, the invention presented relates to an electrolyzer with a possible embodiment of the cell assembly presented.

### BRIEF DESCRIPTION OF THE DRAWINGS

Further advantages, features, and details of the invention will emerge from the following description, in which exemplary embodiments of the invention are described in detail with reference to the drawings. In this context, the features specified in the claims and in the description can each be essential to the invention, individually or in any combination.

In the drawings:

FIG. 1 is a schematic representation of a possible embodiment of the cell assembly according to the invention,

FIG. 2 is a detailed view of two layers of the cell assembly according to FIG. 1,

FIG. 3 is a schematic representation of a possible embodiment of the manufacturing method according to the invention,

FIG. 4 is a schematic representation of a possible embodiment of the fuel cell system according to the invention,

FIG. 5 is a schematic representation of a possible embodiment of the electrolyzer according to the invention.

### DETAILED DESCRIPTION

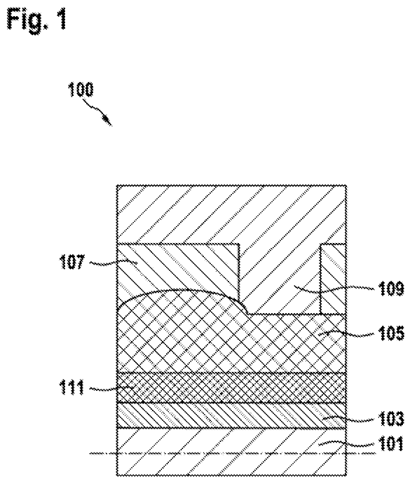

FIG. 1 shows a cell assembly 100. The cell assembly comprises a membrane 101 with a structure consisting of a catalyst layer 103, a microporous layer 105 and an optional support layer 107 made of carbon fleece, which is in fluid-conducting contact with a bipolar plate 109.

The structure on the membrane 101 can be repeated on a side opposite the catalyst layer 103, so that two fluids come together at the membrane 101 and can react with each other or be discharged separately.

According to the invention, the catalyst layer 103 and the microporous layer 105 are intimately connected in that the catalyst layer 103 and the microporous layer 105 fit together in a region 111.

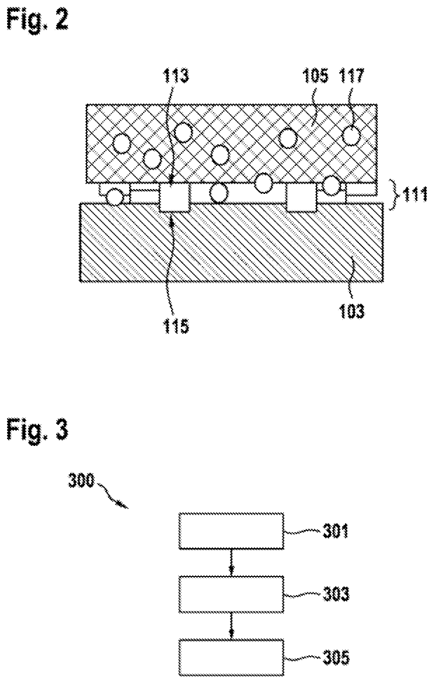

In the region 111, raised regions 113 of a profiling of the microporous layer 105 enter into flat regions 115 of the catalyst layer 103, as shown in detail in FIG. 2. The profiling can, for example, be a 3D pattern, in particular a diamond pattern, which has been applied to the surface of the microporous layer 105 in parts or over the entire surface.

Further, the microporous layer 105 comprises coarse-grained particles 117 that maximize a surface roughness of the microporous layer 105. Accordingly, the particles 117 also enter the region 111 and ensure a maximized contact surface with the catalyst layer 103.

Fitting together in the area 111 creates a particularly large contact surface in which the catalyst layer 103 and the microporous layer 105 interlock. Accordingly, the catalyst layer 103 and the microporous layer 105 adhere particularly strongly to each other and it is more difficult to separate the catalyst layer 103 from the microporous layer 105.

FIG. 3 shows a manufacturing method 300. The manufacturing method comprises an arranging step 301 for arranging a microporous layer on a catalyst layer of a membrane, wherein the microporous layer and/or the catalyst layer is profiled such that a surface roughness of the catalyst layer differs from a surface roughness of the microporous layer such that the catalyst layer and the microporous layer fit together in parts.

Optionally, the manufacturing method 300 comprises a providing step 303 for providing a material forming the catalyst layer on a film having a profiled structure and/or for providing a material forming the microporous layer on a film having a profiled structure.

Further optionally, the manufacturing method 300 comprises a profiling step 305 for profiling the catalyst layer and/or the microporous layer by means of a profiling tool, and/or for profiling the microporous layer by mixing a material forming the microporous layer using a component whose grain size is larger or smaller than a grain size of a component of the catalyst layer.

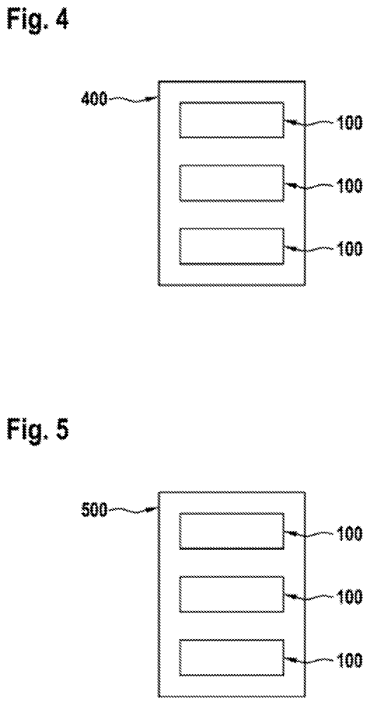

FIG. 4 shows a fuel cell system 400 with the cell assembly 100 according to FIG. 1.

Due to the cell assembly 100 according to the invention, the fuel cell system is particularly durable and has a high power density.

FIG. 5 shows an electrolyzer 500 with the cell assembly 100 according to FIG. 1.

Due to the cell assembly 100 according to the invention, the electrolyzer 500 is particularly durable and efficient.

1. A cell assembly (100) for controlled guidance of reactive fluids,
wherein the cell assembly (100) comprises a membrane (101) having a first side and a second side opposite the first side,
wherein on the first side and the second side are disposed respectively:
a catalyst layer (103),
a microporous layer (105),
the microporous layer (105) and/or the catalyst layer (103) of at least one side is profiled in such a way that a surface roughness of the catalyst layer (103) differs from a surface roughness of the microporous layer (105), so that the catalyst layer (103) and the microporous layer (105) fit together in parts.

2. The cell assembly (100) according to claim 1,
wherein
the microporous layer (105) is hardened by a binder, so that mechanical forces acting on the microporous layer (105) are distributed uniformly in the microporous layer (105).

3. The cell assembly (100) according to claim 2,
wherein
the microporous layer (105) is applied to a carrier layer (107) or is hardened by the binder.

4. The cell assembly (100) according to claim 3,
wherein
the binder comprises electrically conductive components and/or mechanically stiffening components and/or hydrophobizing agents.

5. The cell assembly (100) according to claim 1,
wherein
components of a material forming the microporous layer (105) are at least partially larger or smaller than components of a material forming the catalyst layer (103).

6. The cell assembly (100) according to claim 5,
wherein
the components of the material forming the microporous layer (105) are larger by at least a factor of 2 than the components of the material forming the catalyst layer (103).

7. The cell assembly (100) according to claim 5,
wherein
the components of the material forming the microporous layer (105) comprise graphite with a grain size greater than 1 μm and the components of the material forming the catalyst layer (103) comprise carbon black with a grain size smaller than 1 μm.

8. A manufacturing method (300) for manufacturing a cell assembly (100),
wherein the manufacturing method (300) comprises:
disposal (301) of a microporous layer (105) on a catalyst layer (103) of a membrane (101),
wherein the microporous layer (105) and/or the catalyst layer (103) is or are profiled on at least one side such that a surface roughness of the catalyst layer (103) differs from a surface roughness of the microporous layer (105), so that the catalyst layer (103) and the microporous layer (105) fit together in parts.

9. The manufacturing method (300) according to claim 8,
wherein
wherein the manufacturing method (300) comprises:
providing (303) a material forming the catalyst layer (103) on a film having a profiled structure, and/or
providing (303) a material forming the microporous layer (105) on a film having a profiled structure.

10. The manufacturing method (300) according to claim 8,
wherein the manufacturing method (300) comprises:
profiling (305) of the catalyst layer (103) and/or the microporous layer (105) by a profiling tool, and/or
profiling (305) the microporous layer (105) by mixing a material forming the microporous layer (105) using a component whose grain size is larger or smaller than [[the]]a grain size of a component of the catalyst layer (103).

11. A fuel cell system (400) comprising a cell assembly (100) according to claim 1.

12. An electrolyzer (500) comprising a cell assembly (100) according to claim 1.

13. The cell assembly (100) according to claim 6, wherein the components of the material forming the microporous layer (105) are larger by at least a factor of 5 than the components of the material forming the catalyst layer (103).

14. The cell assembly (100) according to claim 6, wherein the components of the material forming the microporous layer (105) are larger by at least a factor of 10 than the components of the material forming the catalyst layer (103).
